(19) United States
(12) Patent Application Publication
(10) Pub. No.: US 2019/0161418 A1
(43) Pub. Date: May 30, 2019

(54) OIL-SOLUBLE PLANT MICRONUTRIENTS

(71) Applicant: Huntsman Petrochemical LLC, The Woodlands, TX (US)

(72) Inventor: Matthew T. Meredith, Spring, TX (US)

(21) Appl. No.: 16/078,205

(22) PCT Filed: Aug. 4, 2017
(86) PCT No.: PCT/US2017/045485

§ 371 Date: Aug. 21, 2018

Related U.S. Application Data
(60) Provisional application No. 62/376,585, filed on Aug. 18, 2016.

(51) Int. Cl. C05G 3/00; C05G 3/02; C05F 11/00; C05B 15/00; C05D 9/02; A01N 57/20; A01N 37/40

(52) U.S. Cl. CPC C05G 3/0064; C05G 3/02; C05F 11/00; A01N 37/40; C05D 9/02; A01N 57/20; C05B 15/00

(57) ABSTRACT

The present disclosure provides an agricultural adjuvant composition comprising a substantially oil soluble micronutrient salt and an oil. The micronutrient is especially useful as a fertilizer. Accordingly, the adjuvant composition can be combined with a pesticide, for example a water soluble pesticide, to form an agrochemical formulation for application on and delivery of micronutrients to fertilize plants and for killing, inhibiting or repelling pests.

This application claims the benefit of U.S. Provisional Patent Application Ser. No. 62/376,585, filed Aug. 18, 2016, the entire disclosure of which is incorporated herein by reference

### STATEMENT REGARDING FEDERALLY SPONSORED RESEARCH OR DEVELOPMENT

Not Applicable.

### FIELD OF THE INVENTION

The present disclosure is directed to an adjuvant composition comprising (a) a substantially oil soluble micronutrient salt obtained from the reaction of a metal-containing compound and an organic acid and (b) an oil. The adjuvant composition may be combined with a pesticide, such as a water soluble pesticide, to form an agrochemical formulation for application on and delivery of micronutrients to plants.

### BACKGROUND OF THE INVENTION

Certain elements are required by plants in very small quantities for their proper nutrition. These so-called trace elements (also referred to as minor- or micronutrients) generally include boron, calcium, copper, iron, magnesium, manganese, molybdenum, nickel, selenium and zinc. The shortage of one or more of these trace elements can affect the plant appearance and its productivity, giving rise to typical growth problems. Trace element deficiencies in plants are widespread and often occur in soils which contain adequate quantities of the trace elements but in forms unavailable to the plant. For example, the positively charged metal ions are frequently absorbed by soil particles, forming insoluble solid metal hydroxides. Because plants are not able to separate the metals from the hydroxides, the trace elements are lost to them. Sometimes un-complexed metal salts are dissolved and sprayed directly onto the plants, allowing the plants to take them up through vacuoles or other foliar transport systems. Examples of these salts include zinc sulfate, manganese sulfate, sodium borate and ammonium molybdate. Uptake of these salts is inefficient and significantly higher concentrations must be applied to reach the desired levels of uptake, resulting in waste and potential off-target runoff. In addition, uncomplexed salts create significant tank-mix compatibility problems with other fertilizers or pesticides (especially herbicides such as glyphosate or the auxins).

One solution is to deliver metal compounds to the plant in a “protected” or chelated form that are more readily absorbed into the plants via foliar or root uptake and resist forming insoluble hydroxides. Chelates generally comprise a metal and a ligand that holds the metal in a bioavailable form that a plant can use. Examples of such chelates include EDTA, EDDHA, DTPA and NTA. However, the use of these synthetic chelates has significant drawbacks, such as high costs associated with their production, their potential negative interaction when combined with pesticides (i.e. deactivation of the micronutrient and/or pesticide) in an agrochemical formulation, and, more recently, concerns over the fact that they may form byproducts that persist in the environment for extended periods of time. Accumulation in soil and waterways due to the recalcitrant nature of synthetic chelates may lead to a negative impact on the environment. Moreover, EDTA is such an efficient complexor of metal ions that it can compete with the plants for the metal ion, thus resulting in inefficiencies in metal ion delivery to the plant. EDTA can also form complexes with toxic heavy metals in the soil or in runoff areas, resulting in enhanced transport of the heavy metals into plants or waterways.

In addition, it has also been known to use citric acid or citrate salts as a chelating agents. However, the use of citrate has been found to not be generally acceptable due to inferior stability constants at pH's greater than 7 and the rapid biodegradation of citrate in the soil. Moreover, another drawback in relation to use of this compound is its corrosiveness and the damaging effect this can have on equipment used in its delivery, especially if inadvertently mixed in high concentrations.

Finally, it has been known to use aqueous solutions of insoluble forms of the micronutrients (ZnO, CuO, MnCO₃, MgCO₃, etc.). However, because these solid micronutrients have such a low solubility in any solvent, they are not efficiently taken up by plants.

While the use of synthetic chelates, organic acids or aqueous solutions of insoluble forms of the micronutrients have become the standard accepted way of providing micronutrients to plants on the thought that such agents were the best possible and most efficient compounds available, there is a need to develop more environmentally acceptable and effective compounds for use in the delivery of micronutrients to plants.

### SUMMARY OF THE INVENTION

The present disclosure provides an adjuvant composition comprising a micronutrient salt and an oil. The micronutrient salt is obtained from the reaction of a metal-containing compound comprising boron, calcium, copper, iron, magnesium, manganese, molybdenum, nickel, selenium, zinc or a mixture thereof, and an organic acid comprising a sulfonic acid, a carboxylic acid, a phosphorous acid, a boric acid or a mixture thereof wherein the organic acid has a sufficient number of carbon atoms to render the micronutrient salt that is formed substantially oil soluble. The adjuvant composition may also comprise a surfactant and an auxiliary component(s).

The present disclosure also provides an agrochemical formulation comprising the adjuvant composition above and a pesticide. In particular aspects, the pesticide may be a water soluble pesticide, including but not limited to, glyphosate, 2,4-D, dicamba and glufosinate.

The present disclosure also provides a method for killing, inhibiting or repelling a pest which includes contacting the agrochemical formulation and the pest.

### DETAILED DESCRIPTION OF THE INVENTION

The present disclosure provides an adjuvant composition comprising a micronutrient salt and an oil. The micronutrient salt, particularly useful as a fertilizer, may be obtained by reacting (i) a metal-containing compound comprising boron, calcium, copper, iron, magnesium, manganese, molybdenum, nickel, selenium, zinc or a mixture thereof with (ii) an organic acid comprising a sulfonic acid, a carboxylic acid, a phosphorus acid, a boric acid or a mixture thereof, where the organic acid has a sufficient number of carbon atoms to render the micronutrient salt that is formed substantially oil soluble. In some aspects the adjuvant composition is substantially free of a chelate. Surprisingly, it has been found the oil-soluble micronutrient salt, when added to an oil and optionally surfactant and auxiliary component(s), is readily emulsifiable into water and can be added to an agricultural spray tank with or without tank mix partners, such as other fertilizers and/or pesticides.

In addition, it has also been surprisingly found that the adjuvant composition of the present disclosure may be useful in agrochemical formulations for enhancing efficacy of the active ingredients, especially water soluble pesticides, in the agrochemical formulations. By “enhanced” it is to be understood that the adjuvant composition comprising the substantially oil soluble micronutrient and oil of the present disclosure increases the performance of the active ingredients, for example water soluble pesticides, in agrochemical formulations (for e.g., a higher activity of the active ingredients for a given application rate, a lower application rate with a given effect, better uptake of the active ingredient by the target substrate, and thus advantages for a pre-emergence or post-emergence treatment, in particular the spray treatment of target substrates) as compared to agrochemical formulations that do not contain the adjuvant composition of the present disclosure. In particular, it's known that state of the art micronutrient salts (for e.g., manganese sulfate and zinc sulfate) interfere with and can deactivate water soluble pesticides, such as glyphosate, 2,4-D, dicamba and glufosinate. However, the substantially oil soluble micronutrient salts of the present disclosure are capable of being substantially dispersed in oil allowing them to be used with such pesticides without detrimental effects.

The following terms shall have the following meanings:

As used herein, the term “plant” includes reference to whole plants, plant organ, for e.g., leaves, stems, roots, plant tissue, seeds, and plant cells and progeny thereof. Plant cell, as used herein includes, without limitation, seeds, for e.g., seed suspension cultures, embryos, meristematic regions, callus tissue, leaves, roots, shoots, gametophytes, sporophytes, pollen, and microspores.

The term “micronutrient” means an element that is essential in trace amounts for plant growth. Examples of such micronutrients include, but are not limited to, boron, calcium, copper, iron, manganese, magnesium, molybdenum, nickel, selenium and zinc.

The term a “pesticidally effective amount” refers to that amount of a pesticide which, upon application, either reduces the presence of pests or enhances a plant's resistance to a pest.

The term “target substrate” refers to sites underlying plant foliage which are the intended destination for the pesticide including, but not limited to: natural ground surfaces, such as soil and water (lakes, ponds, marshes, swamps, streams, puddles, etc.); artificial surfaces, such as pavement; a pest or a combination thereof.

The term “pest” generally includes insects, mites, ticks and other arthropods, disease agents, such as fungi, protozoa, bacteria and viruses. helminths, nematodes (roundworms), cestodes (tapeworms), platyhelminths (flatworms), trematodes (flukes) and other worms, sporozoan parasites, slugs and snails, and vertebrates such as birds, rodents or other vertebrates which can directly or indirectly injure or cause disease or damage in any plant or part thereof or any processed, manufactured or other product of the plant.

The term “chelate” means a coordination compound in which a central metal ion is attached by coordinate links to two or more nonmetal ligands, for example, EDTA or an amino acid, which form heterocyclic rings with the metal ion being a part of each ring.

The term “substantially free” means, when used with reference to the substantial absence of a component in a composition, that such a component is present, if at all, as an incidental impurity or by-product. In other words, the component does not affect the properties of the composition.

The phrase “substantially oil soluble” indicates that the indicated component is present in an oil phase in an amount of at least 95% by weight, or at least 97% by weight, or at least 99% by weight, or even at least 99.5% by weight, based on the total weight of the oil phase.

It shall be understood, that “organic acid” may also include metallic salts of the organic acid moiety. For example, in some aspects, the organic acid includes a sulfonic acid or metallic salt thereof, a carboxylic acid or metallic salt thereof, a phosphorus acid or metallic salt thereof, or a boric acid or metallic salt thereof.

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or more than one (i.e. to at least one) of the grammatical object of the article. By way of example, “an oil” means one oil or more than one oil.

The phrases “in one aspect”, “according to one aspect” and the like generally mean the particular feature, structure, or characteristic following the phrase is included in at least one aspect of the present disclosure, and may be included in more than one aspect of the present disclosure. Importantly, such phrases do not necessarily refer to the same aspect.

If the specification states a component or feature “may”, “can”, “could”, or “might” be included or have a characteristic, that particular component or feature is not required to be included or have the characteristic.

According to one aspect, the present disclosure provides an adjuvant composition comprising: a micronutrient salt obtained from the reaction of a metal-containing compound and an organic acid, and in some aspects, an organic acid or salt thereof; and an oil, wherein the organic acid (or salt thereof) has a sufficient number of carbon atoms to render the micronutrient salt that is formed substantially oil soluble. It has been surprisingly found the micronutrient salts of the present disclosure are substantially oil soluble, and therefore exhibit enhanced hydrophobicity allowing them to be easily formulated into oil-based agrochemical formulations for application onto plants. Because of this enhanced hydrophobicity, additional adjuvancy normally not present is built into these oil-based compositions allowing the micronutrient salts to penetrate/enter the targeted plant (for e.g. leaf cuticle) more quickly and efficiently than traditional water-soluble micronutrient salts. Finally, in contrast to state of the art water soluble micronutrient salts, the substantially oil soluble micronutrient salts will not interfere with or deactivate water soluble pesticides, such as glyphosate, 2,4-D, dicamba and glufosinate, and therefore have the capability to be successfully used in combination with these water soluble pesticides in various applications, such as in spray tank applications.

According to one or more aspects, the substantially oil soluble micronutrient salt is obtained from the reaction of (i) a metal-containing compound comprising boron, calcium, copper, iron, magnesium, manganese, molybdenum, nickel, selenium, zinc or mixture thereof and (ii) an organic acid comprising a sulfonic acid, a carboxylic acid, a phosphorus acid, a boric acid or a mixture thereof.

In one aspect, the metal-containing compound is a metal oxide, a metal carbonate, a metal hydroxide or a mixture thereof of boron, calcium, copper, iron, manganese, magnesium, molybdenum, nickel, selenium or zinc. In another aspect, the metal-containing compound is a metal oxide, a metal carbonate, a metal hydroxide or a mixture thereof of calcium, manganese, magnesium or zinc. In still another aspect, the metal-containing compound is a metal oxide of calcium, manganese, magnesium or zinc. In yet another aspect, the metal-containing compound is a metal oxide of manganese or zinc.

Examples of the metal-containing compound may include, but are not limited to, calcium oxide, calcium hydroxide, calcium carbonate, zinc oxide, zinc hydroxide, zinc carbonate, boron trioxide, manganese oxide, magnesium hydroxide, molybdenum trioxide, magnesium oxide, magnesium hydroxide, copper (II) oxide, iron (III) oxide, selenium hydroxide, nickel oxide, nickel hydroxide, nickel carbonate and mixtures thereof.

The organic acid that is reacted with the metal-containing compound is one selected from a sulfonic acid, a carboxylic acid, a phosphoric acid, a boric acid and a mixture thereof. The number of carbon atoms for the particular organic acid is not limited so long as it has a sufficient number of carbon atoms to render the micronutrient salt that is formed substantially oil soluble. Thus, the number carbon atoms of the organic acid will vary depending on the particular metal-containing compound and the particular organic acid used in forming the micronutrient salt. In some aspects, the number of carbon atoms of the organic acid may be less than 30, in other aspects less than 20 carbon atoms, in still other aspects less than 15 carbon atoms, while in still other aspects the number of carbon atoms may be less than 10. In a further aspect, the number of carbon atoms of the organic acid may be more than 3, in other aspects more than 5 carbon atoms, in still other aspects more than 10 carbon atoms, while in still other aspects it may be more than 15 carbon atoms. In still further aspects, the number of carbon atoms of the organic acid may range from 1 to 30, or from 4 to 25 or even from 8 to 15.

According to one aspect, the organic acid is a sulfonic acid. The sulfonic acid may be represented by the general formula

R₁SO₃H or (R₁)ₓArSO₃H

wherein R₁ is a hydrocarbyl based group having less than 30 carbon atoms, and can be, for example, an aliphatic group such as alkyl, alkenyl, alkoxy, alkoxyalkyl, or a carboalkoxyalkyl group; x is an integer of 1 to 3; and, Ar is an aromatic hydrocarbon nucleus, including, but not limited to, a benzene or naphthalene nucleus. The groups Ar and R₁ above can also contain other substituents such as hydroxy, mercapto, halogen, nitro, amino, nitroso, carboxy and lower carboalkoxy as long as the essential hydrocarbon character of the Ar and R₁ groups is not destroyed.

Examples of sulfonic acids include, but are not limited to, mahogany sulfonic acids, alkylated aromatic sulfonic acids, petrolatum sulfonic acids, mono- and polywax-substituted naphthalene sulfonic acids, cetylchlorobenzene sulfonic acids, cetylphenol sulfonic acids, cetylphenol disulfide sulfonic acids, cetoxycapryl benzene sulfonic acids, dicetyl thianthrene sulfonic acids, di-lauryl beta-naphthol sulfonic acids, dicapryl nitronaphthylene sulfonic acids, paraffin wax sulfonic acids, unsaturated paraffin wax sulfonic acids, hydroxy-substituted paraffin wax sulfonic acids, tetraisobutylene sulfonic acids, tetraamylene sulfonic acids, chloro-substituted paraffin wax, nitrosyl-substituted paraffin wax sulfonic acids, petroleum naphthene sulfonic acids, cetylcyclopentyl sulfonic acids, lauryl cyclohexyl sulfonic acids and mono- and polywax-substituted cyclohexyl sulfonic acids.

In another aspect, the organic acid is a carboxylic acid. The carboxylic acid may be a mono- or polycarboxylic acid (if the latter, it is generally a di- or tricarboxylic acid). Monocarboxylic acids include C₁-C₇ lower acids (for e.g. acetic, proprionic, butryric acid) and higher C₈₊ acids (for e.g., octanoic, decanoic, etc.) as well as known fatty acids having about 12-30 carbon atoms. The fatty acids are often mixtures of straight and branched chain acids containing, for example, from about 5% to about 30% (moles) straight chain acids and about 70% to about 95% (moles) branched chain acids. Other commercially available fatty acid mixtures containing much higher proportions of straight chain acids are also useful. Mixtures produced from dimerization of unsaturated fatty acids can also be used.

In addition, dicarboxylic acids may include the well-known dicarboxylic acids made by alkylating maleic anhydride or its derivatives. The products of such reactions are hydrocarbon substituted succinic acids, anhydrides, and the like. Lower molecular weight dicarboxylic acids, such as polymethylene bridged acids (glutaric, adipic, and the like), can also be used to make the substantially oil soluble micronutrients salts of this disclosure. Non-exclusive examples of tricarboxylic acids include citric acid, isocitric acid, aconitic acid, propane-1,2,3-tricarboxylic acid and trimersic acid.

In yet another aspect the organic acid is a phosphorus acid. The phosphorus acid compounds, which contain phosphorus having a valence of 3 or 5 include:

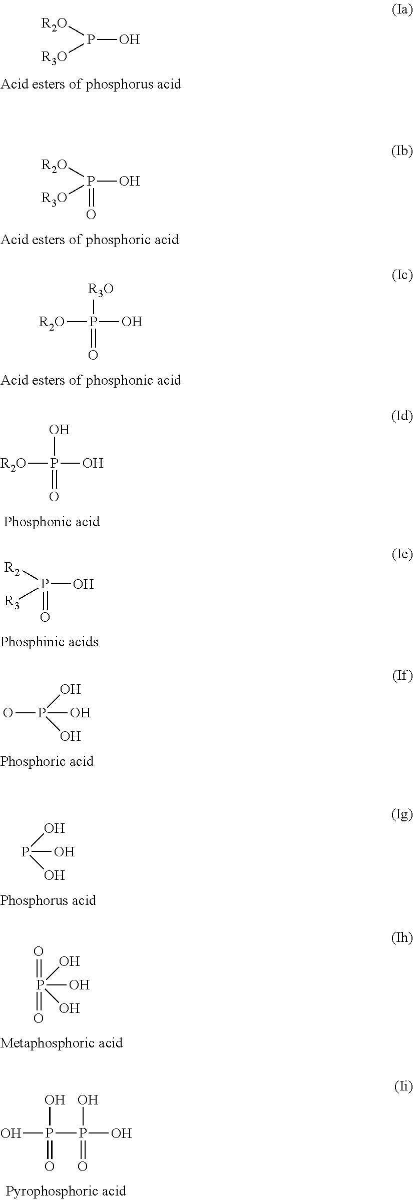

wherein R₂ and R₃ are each, independently an aliphatic, aromatic or non-aromatic alicyclic hydrocarbon or heterocyclic radical having from 1 to 30 carbon atoms.

Examples of phosphorus acids include, but are not limited to, di(phenyl) phosphite, monophenyl phosphite, mono-(diphenyl) phosphite, dicresyl phosphite, di-(oisooctylphenyl) phosphite, di(p-ethylhexlphenyl) phosphite, di(p-t-octylphenyl) phosphite, di(dimethylphenyl) phosphite, di-n-butyl phosphite, di-2-ethylhexyl phosphite, mono-2-ethyl hexyl phosphite, diisooctyl phosphite, monoisooctyl phosphite, monododecyl phosphite, 2-ethylhexyl phenyl phosphite, 2-ethylhexyl-(n-octylphenyl) phosphite, monocyclohexyl phosphite, dicyclohexyl phosphite, di(2-cyclohexyl phenyl) phosphite, di-α-naphthyl phosphite, dipenyl phenyl phosphite, di(diphenyl) phospite, di-(2-phenyl ethyl) phosphite, dibenzyl phosphite, monobenzyl phosphite, n-butyl cresyl phosphite, didodecyl phosphite, ditetrahydrofurfuryl phosphite, difuryl phosphite, diphenyl phosphate, monophenyl phosphate, dicresyl phosphate, di(dimetylphenyl) phosphate, di-n-butyl phosphate, di(p-t-octylphenyl) phosphate, di(o-t-octylphenyl) phosphate, di(2-ethylhexylphenyl) phosphate, di-2-ethylhexyl phosphate, mono-2-ethylhexyl phosphate, diisooctyl phosphate monoisooctyl phosphate, monododecyl phosphate, 2-ethylhexyl phenyl phosphate, 2-ethylhexyl-(p-t-octyl phenyl) phosphate, dicyclohexyl phosphate, monocyclohexyl phosphate, ditetrahydrofurfuryl phosphate, difuryl phosphate, di(2cyclohexyl phenyl) phosphate, di-α-naphthyl phosphate, di(diphenyl) phosphate, diphenyl phenyl phosphate, di(2-phenyl ethyl) phosphate, dibenzyl phosphate, monobenzyl phosphate, n-butyl cresyl phosphate, didodecyl phosphate, benzene phosphonic acid, 2-ethylhexyl phosphonic acid, n-butyl phosphonic acid, isoamyl phosphonic acid, cyclohexyl phosphonic acid, α-naphthyl phosphonic acid, benzyl phosphonic acid, 2-phenylethyl phosphonic acid, tolyl phosphonic acid, 2-cyclohexyl phenyl phosphonic acid and diphenyl phosphonic acid, phenyl ethyl acid phosphonate, 2-ethyl-hexyl phenyl acid phosphonate, di(2-ethylhexyl) acid phosphonate, cresyl tolylacid phosphonate, di(phenyl) acid phosphonate, di(cyclohexyl) acid phosphonate, di(tetrahydrofurfuryl) acid phosphonate, diphenyl phosphinic acid, di-2-ethylhexyl phosphinic acid, di(t-octylphenyl) phosphinic acid, 2-ethylhexyl phenyl phosphinic acid, isobutyl-2-ethylhexyl phosphinic acid, di-n-propyl phosphinic acid, di-α-naphthyl phosphinic acid, dicyclohexyl phosphinic acid, ditolyl phosphinic acid, dibenzyl phosphinic acid, isooctyl benzyl phosphinic acid, di(2-phenyl ethyl) phosphinic acid, diphenyl phenyl phosphinic acid, di(diphenyl) phosphinic acid, 2-etylhexyl (t-octyl phenyl) phosphinic acid and di(dimethylphenyl) phosphinic acid.

In another aspect, the organic acid is a boric acid. The boric acid may be any of the various forms of boric acid, including metaboric acid (HBO₂), orthoboric acid (H₃BO₃) and tetraboric acid (H₂B₄O₇). The boric acid may also be an ester of these acids including, for example, the methyl, ethyl and propyl esters, with the methyl esters being most readily available and therefore most often used.

The substantially oil soluble micronutrient salt may be obtained by reacting the metal-containing compound and organic acid in an organic solvent. After the reaction is complete, the organic solvent may be removed so that the substantially oil soluble micronutrient salt is isolated.

The reaction between the organic acid and metal-containing compound may be carried out by using 2 to 3 moles, or using 2 to 2.5 moles, or even using 1.5 moles to 2 moles of the organic acid with respect to 1 mole of the metal-containing compound.

Organic solvents that can be used include a hydrocarbon solvent, an alcohol solvent, an ester solvent, or an ether solvent. Examples of the hydrocarbon solvent include n-hexane, n-octane, cyclohexane, toluene, and xylene. Examples of the alcohol solvent include methanol, ethanol, propanol, butanol, ethylene glycol, and propylene glycol. Examples of the ester solvent include ethyl acetate, butyl acetate, ethylene glycol monomethyl ether acetate, and propylene glycol monomethyl ether acetate. Examples of the ether solvent include ethylene glycol monomethyl ether, ethylene glycol monoethyl ether, and propylene glycol monomethyl ether. These solvents can be used alone or in combination of two or more.

The reaction between the metal-containing compound and organic acid may occur at any suitable temperatures, such as at a temperature between 40° C. to 95° C., or at a temperature between 40° C. to 90° C., or even at a temperature between 40° C. to 80° C.

Once the reaction is complete, the solvent can be removed at a temperature of 80° C. or less, or at a temperature of 70° C. or less, or even at a temperature of 60° C. or less. The solvent can be removed by methods commonly used by those skilled in the art. For example, such methods include drying under reduced pressure, lyophilization, spray drying, or air blow drying. It is preferable in one aspect that solvent removal is performed in a time that is as short as possible.

The adjuvant composition also includes an oil. In one or more aspects, the oil may be a vegetable oil, a mineral oil, a paraffin oil, a fatty acid ester or a mixture thereof

According to one aspect, the oil is a vegetable oil. Examples of vegetable oils include, but are not limited to, soybean oil, coconut oil, palm oil, cotton seed oil, wheat germ oil, olive oil, corn oil, sunflower oil, safflower oil, rapeseed oil, mustard oil, tallow, palmitate, stearate, oleate, linoleate, soybean oil methyl ester, soybean oil ethyl ester, soybean oil propyl ester, coconut oil methyl ester, coconut oil ethyl ester, coconut oil propyl ester, palm oil methyl ester, palm oil ethyl ester, palm oil propyl ester, cotton seed oil methyl ester, cotton seed oil ethyl ester, cotton seed oil propyl ester, wheat germ methyl ester, wheat germ ethyl ester, wheat germ propyl ester, olive oil methyl ester, olive oil ethyl ester, olive oil propyl ester, corn oil methyl ester, corn oil ethyl ester, corn oil propyl ester, sunflower oil methyl ester, sunflower oil ethyl ester, sunflower oil propyl ester, safflower oil methyl ester, safflower oil ethyl ester, safflower oil propyl ester, rapeseed oil methyl ester (biodiesel), rapeseed oil ethyl ester, rapeseed oil propyl ester, mustard oil methyl ester, mustard oil ethyl ester, mustard oil propyl ester, jatropha methyl ester, jatropha ethyl ester, jatropha propyl ester, tallow methyl ester, tallow ethyl ester, tallow propyl ester, methyl palmitate, ethyl palmitate and propyl palmitate.

In another aspect, the oil is a mineral oil. Suitable mineral oils generally include various commercially available distillate fractions of mineral oil (petroleum). In one aspect, preference is given to mixtures of open-chain C₁₄-C₃₀ hydrocarbons, cyclic hydrocarbons (naphthenes) and aromatic hydrocarbons. The hydrocarbons can be either straight-chain or branched. In another aspect, particular preference is given to mixtures having an aromatic portion of less than 8% by weight or even mixtures having an aromatic portion of less than 4% by weight.

In still another aspect, the oil is a paraffin oil. Examples of such paraffin oils are straight-chain and branched C₁₄-C₃₀ hydrocarbons. Paraffin oils are also known as base oil or white oil and are commercially available, for example, under the Bayol® and Marcol® brand oils, BAR 0020 oil, Pionier 0032-20 oil or, Kristol M14 oil.

In a further aspect, the oil is a fatty acid ester. Suitable fatty acid esters generally include alkyl fatty acid esters, such as C₁-C₂₀ alkyl C₁₀-C₂₂ fatty acid esters. In one aspect, preference is given to methyl esters, ethyl esters, propyl esters, butyl esters, 2-ethylhexyl esters and dodecyl esters and mixtures thereof. In another aspect, particular preference is given to methyl esters and ethyl esters. Examples of synthetic fatty acid esters are, for example, those which are derived from fatty acids having an odd number of carbon atoms, such as C₁₁-C₂₁-fatty acid esters.

In another aspect, the adjuvant composition may contain a surfactant.

Surfactants are surface-active compounds, such as anionic, cationic, nonionic and amphoteric surfactants, block polymers, polyelectrolytes, and mixtures thereof. Such surfactants can be used as an emulsifier, dispersant, solubilizer, wetter, penetration enhancer or protective colloid. Examples of surfactants useful in the present disclosure are listed in McCutcheon's, Vol. 1: Emulsifiers & Detergents, McCutcheon's Directories, Glen Rock, USA, 2008 (International Ed. or North American Ed.), the contents of which is herein incorporated by reference.

Anionic surfactants may include alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Nonionic surfactants may include alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters. Examples of polymeric surfactants are homo- or copolymers of vinylpyrrolidone, vinylalcohols, or vinylacetate.

Cationic surfactants may include quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

The adjuvant composition may also contain an auxiliary component. Examples of auxiliary components include, but are not limited to, emulsifiers, solvents, liquid carriers, solid carriers or fillers, dispersants, wetters, adjuvants, solubilizers, penetration enhancers, protective colloids, adhesion agents, thickeners, humectants, repellents, attractants, feeding stimulants, compatibilizers, bactericides, anti-freezing agents, crystallization inhibitors, anti-foaming agents, colorants, tackifiers, binders, preservatives, inorganic or organic acids to neutralize the pH, clarifiers, stabilizers, fertilizers, such as ammonium sulfate, urea or compound fertilizers, for example phosphorus-, potash- and nitrogen-based compound fertilizers, such as P, K, N fertilizers, UV stabilizers and mixtures thereof.

Examples of emulsifiers which may be used are calcium salts of alkylarylsulfonic acid, such as calcium dodecylbenzenesulfonate, or nonionic emulsifiers such as fatty acid polyglycol esters, alkylaryl polyglycol ethers, fatty alcohol polyglycol ethers, propylene oxidelethylene oxide condensates, alkyl polyethers, sorbitan esters such as, for example, sorbitan fatty acid esters, or polyoxyethylene sorbitan esters such as, for example, polyoxyethylene sorbitan fatty acid esters.

Solvents and liquid carriers can be water and organic solvents, such as aliphatic, cyclic and aromatic hydrocarbons, for e.g. toluene, paraffin, tetrahydronaphthalene, alkylated naphthalenes; alcohols, for e.g. ethanol, propanol, butanol, benzylalcohol, cyclohexanol; glycols; DMSO; ketones, for e.g. cyclohexanone; esters, for e.g. lactates, carbonates, fatty acid esters, gamma-butyrolactone; fatty acids; phosphonates; amines; amides, for e.g. N-methylpyrrolidone, fatty acid dimethylamides; and mixtures thereof. In one aspect, the solvent is an organic solvent.

Crystallization inhibitors can be polyacrylic acids and their salts, whereas the latter are preferred. The salts of polyacrylic acids may be ammonium, primary, secondary or tertiary ammonium derivatives, or alkali metal salts (e.g. sodium, potassium, lithium ions), wherein alkali metal salts such as sodium salts are preferred in one aspect. The polyacrylic acids and their salts usually have a molecular weight (as determined by GPC, calibration with polystyrene sulphonates) of 1000 Da to 300 kDa, alternatively of 1000 Da to 80 kDa, and in particular 1000 Da to 15 kDa. The crystallization inhibitors are usually water-soluble, for e.g. at least 1 g/l, alternatively at least 10 g/l, and in particular at least 100 g/l at 20° C.

Solid carriers or fillers can be mineral earths, for e.g. silicates, silica gels, talc, kaolins, limestone, lime, chalk, clays, dolomite, diatomaceous earth, bentonite, polysaccharide powders, for e.g. cellulose, starch, products of vegetable origin, for e.g. cereal meal, tree bark meal, wood meal, nutshell meal, and mixtures thereof.

Thickeners include polysaccharides (for e.g., xanthan gum, carboxymethylcellulose), organic clays (organically modified or unmodified), polycarboxylates, and silicates.

Bactericides include bronopol and isothiazolinone derivatives such as alkylisothiazolinones and benzisothiazolinones.

Anti-freezing agents include ethylene glycol, propylene glycol and glycerin.

Anti-foaming agents include silicones, long chain alcohols, and salts of fatty acids. Preferred anti-foaming agents are silicones, such as polydimethylsiloxane.

Colorants (for e.g., in red, blue, or green) include pigments of low water solubility and water-soluble dyes. Examples are inorganic colorants (for e.g., iron oxide, titan oxide, iron hexacyanoferrate) and organic colorants (for e.g., alizarin-, azo- and phthalocyanine colorants).

Tackifiers or binders include polyvinylpyrrolidone, polyvinylacetates, polyvinyl alcohols, polyacrylates, biological or synthetic waxes, and cellulose ethers.

Anti-drift agents are, for example, nonionic polymers, such as polyacrylamides, polyethylene glycols, or guar gum with a molecular weight of at least 20 kDa, preferably at least 50 kDa, and in particular at least 100 kDa. Further examples for anti-drift agents are lecithin and self emulsifiable polyesters.

Humectants are typically compounds, which attract and/or keep water within the adjuvant composition. Examples include glycerol or sugar syrups.

In one exemplary aspect, the adjuvant composition comprises (a) 0.01% by weight to 20% by weight of the substantially oil soluble micronutrient salt of the present disclosure and (b) 0.01% by weight to 45% by weight of the oil, where the % by weight is based on the total weight of the adjuvant composition. In another exemplary aspect, the adjuvant composition comprises (a) 0.5% by weight to 15% by weight of the substantially oil soluble micronutrient salt of the present disclosure and (b) 1% by weight to 35% by weight of the oil, where the % by weight is based on the total weight of the adjuvant composition. In still another exemplary aspect, the adjuvant composition comprises (a) 1% by weight to 10% by weight of the substantially oil soluble micronutrient salt of the present disclosure and (b) 5% by weight to 30% by weight of the oil, where the % by weight is based on the total weight of the adjuvant composition.

In another exemplary aspect, the adjuvant composition comprises (a) 0.01% by weight to 20% by weight of the substantially oil soluble micronutrient salt of the present disclosure (b) 0.01% by weight to 45% by weight of the oil and (c) 0.1% by weight to 25% by weight of the surfactant, where the % by weight is based on the total weight of the adjuvant composition. In still another exemplary aspect, the adjuvant composition comprises (a) 0.5% by weight to 15% by weight of the substantially oil soluble micronutrient salt of the present disclosure (b) 1% by weight to 35% by weight of the oil, and (c) 0.5% by weight to 20% by weight of the surfactant, where the % by weight is based on the total weight of the adjuvant composition. In yet another exemplary aspect, the adjuvant composition comprises (a) 1% by weight to 10% by weight of the substantially oil soluble micronutrient salt of the present disclosure (b) 5% by weight to 30% by weight of the oil and (c) 1% by weight to 15% by weight of the surfactant, where the % by weight is based on the total weight of the adjuvant composition.

In yet another exemplary aspect, the adjuvant composition comprises (a) 0.01% by weight to 20% by weight of the substantially oil soluble micronutrient salt of the present disclosure (b) 0.01% by weight to 45% by weight of the oil, (c) 0.1% by weight to 25% by weight of the surfactant and (d) 0.1% by weight to 90% by weight of an auxiliary component, where the % by weight is based on the total weight of the adjuvant composition. In another exemplary aspect, the adjuvant composition comprises (a) 0.5% by weight to 15% by weight of the substantially oil soluble micronutrient salt of the present disclosure (b) 1% by weight to 35% by weight of the oil, (c) 0.5% by weight to 20% by weight of the surfactant and (d) 1% by weight to 50% by weight of an auxiliary component, where the % by weight is based on the total weight of the adjuvant composition.

The adjuvant compositions of the present disclosure can be easily be prepared in any suitable vessel or container. The order of mixing the components is not particularly important and generally the various components can be added sequentially or all at once. Thus, the aqueous compositions may be prepared by combining: (i) the substantially oil soluble micronutrient salt with (ii) the oil and optionally (iii) surfactant and optionally (iv) auxiliary component(s). Each of the above may be combined at any suitable temperature such as at temperatures ranging from 10° C. to 70° C.

Once formulated, the adjuvant compositions may be packaged in a variety of containers such as steel, tin, or aluminum cans, plastic or glass bottles and paper or cardboard containers.

In a further aspect, there is provided an agrochemical formulation comprising the adjuvant composition of the present disclosure and a pesticide (and auxiliary component(s) in aspects where such auxiliary component(s) are present in the agrochemical formulation and were not included in formulating the adjuvant composition). The agrochemical formulation may be used in treating target substrates such as those disclosed above and refers to all forms of compositions including concentrates and spray formulations. “Spray formulations” are aqueous agrochemical formulations that include all of the components to be applied to the target substrate or their environment in a form and at a concentration (dilution) that is appropriate for spraying. Spray formulations can be made up by simple dilution of concentrates containing desired components, by mixing the individual components, or a combination of diluting a concentrate and adding further individual components or mixtures of components. Typically such end use mixing is carried out in the spray tank from which the formulation is sprayed or a holding tank for filling the spray tank and commonly such mixing and mixtures are called tank mixing and tank mixtures. “Concentrates” are agrochemical formulations, which may be aqueous or non-aqueous, and which are designed to be diluted with water (or a water-based liquid) to form the corresponding spray formulations and include such compositions in liquid form such as solutions, emulsions or dispersions and in solid form, especially in water dispersible solid form, such as granules or powders. The agrochemical formulations according to the present disclosure may be prepared by customary processes, for example by mixing, by grinding, dissolving or dispersing the individual components, preferably at room temperature or ambient conditions. If other formulation auxiliary components are present, they are likewise incorporated at room temperature or ambient conditions. In general, the sequence in which the individual components are added is of no decisive importance. Thus, in one aspect the adjuvant composition disclosed above may be formulated in a container, for example, in a stainless steel tank, steel, tin, aluminum can, plastic or glass bottle and paper or cardboard container. The adjuvant composition may then be combined with a pesticide and water and/or other solvent, and in some aspects an auxiliary component, to form an agrochemical formulation in the field just prior to application.

The presently described adjuvant composition is not limited for use with any particular class of pesticides. In some particular aspects, the adjuvant composition is used in connection with water soluble pesticides, such as glyphosate, 2,4-D, dicamba and glufosinate.

In one aspect, the pesticide includes any chemical or biological agent (i.e. “active ingredient”) used in preventing, destroying, repelling, or mitigating a pest. Thus, in one particular aspect, the pesticide is a fungicide, herbicide, insecticide, algaecide, molluscicide, miticide, rodenticide, growth regulator or insect repellant.

According to one aspect, the pesticide is a fungicide. Examples of fungicides include, but are not limited to: azoxystrobin, trifloxystrobin, kresoxim methyl, famoxadone, metominostrobin and picoxystrobin, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, carboxin, metalaxyl, bupirimate, ethirimol, dimoxystrobin, fluoxastrobin, orysastrobin, metominostrobin, prothioconazole, 8-(2,6-diethyl-4-methyl-phenyl)tetrahydropyrazolo[1,2-d][1,4,5]oxadiazepine-7,9-dione, 2,2,-dimethyl-propionic acid-8-(2,6-diethyl-4-methyl-phenyl)-9-oxo-1,2,4,5-tetrahydro-9H-pyrazolo-[1,2 d][1,4,5]oxadiazepine-7-yl ester and metalaxyl.

In another aspect, the pesticide is a herbicide. Examples of herbicides include, but are not limited to: fluzifop, mesotrione, fomesafen, tralkoxydim, napropamide, amitraz, propanil, cyprodanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, indol-3-yl acetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, oxyfluorfen, acifluorfen, fluoroglycofen-ethyl, bromoxynil, ioxynil, imazamethabenz-methyl, imazapyr, imazaquin, imazethapyr, imazapic, imazamox, flumioxazin, flumiclorac-pentyl, picloram, amodosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron, metoxuron, N-phosphonomethylglycine and its salts (glyphosate), glufosinate, chlormequat chloride, paraquat, diquat, trifloxysulfuron, fomesafen, mesotrione and fenuron.

In yet another aspect, the pesticide is an insecticide. Examples of insecticides include, but are not limited to: abamectin, acephate, acetamiprid, acrinathrin, alanycarb, aldicarb, allethrin, alpha-cypermethrin, amitraz, asulam, azadirachtin, azamethiphos, azinphos-ethyl, azinphos-methyl, bendiocarb, benfuracarb, bensultap, beta-cyfluthrin, beta-cypermethrin, bifenthrin, bioallethrin, bioresmethrin, bistrifluron, borax, buprofezin, butoxycarboxim, cadusafos, carbaryl, carbofuran, chlorpropham, clothianidin, cyfluthrin, cyhalothrin, cyprmethrin, deltamethrin, diethofencarb, diflubenzuron, dinotefuran, emamectin, endosulfan, fenoxycarb, fenthion, fenvalerate, fipronil, halfenprox, heptachlor, hydramethylnon, imidacloprid, imiprothrin, isoprocarb, lambda cyhalothrin, methamidophos, methiocarb, methomyl, nitenpyram, omethoate, permethrin, pirimicarb, pirimiphos methyl, propoxur, tebufenozide, thiamethoxam, thiodicarb, triflumoron, and xylylcarb.

In still another aspect, the pesticide is an algaecide. Examples of algaecides include, but are not limited to: bethoxazin, copper dioctanoate, copper sulfate, cybutryne, dichlone, dichlorophen, endothal, fentin, hydrated lime, nabam, quinoclamine, quinonamid, simazine, triphenyltin acetate, and triphenyltin hydroxide.

In a further aspect, the pesticide is a molluscicide. Examples of moluscicides include, but are not limited to: metaldehyde, methiocarb and aluminium sulfate.

In still a further aspect, the pesticide is a miticide. Examples of miticides include, but are not limited to: antibiotic miticides, carbamate miticides, formamidine miticides, mite growth regulators, organochlorine, permethrin and organophosphate miticides.

In an additional aspect, the pesticide is a rodenticide. Examples of rodenticides include, but are not limited to: 2-isovalerylindan-1, 3-dione, 4-(quinoxalin-2-ylamino)benzenesulfonamide, alpha-chlorohydrin, aluminium phosphines, anta, arsenics oxide, barium carbonate, bisthiosemi, brodifacoum, bromadiolone, bromethalin, calcium cyanide, chloralose, chlorophacinone, cholecalciferol, coumachlor, coumafuryl, coumatetralyl, crimidine, difenacoum, difethialone, diphacinone, ergocalciferol, flocoumafen, fluoroacetamide, flupropadine, flupropadine hydrochloride, gamma-HCH, HCH, hydrogen cyanide, iodomethane, lindane, magnesium phosphide, methyl bromide, norbormide, phosacetim, phosphine, phosphorus, pindone, potassium arsenite, pyrinuron, scilliroside, sodium arsenite, sodium cyanide, sodium fluoroacetate, strychnine, thallium sulfate, warfarin, and zinc phosphide.

In still another aspect, the pesticide is a growth regulator. Examples include, but are not limited to, abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole.

According to another aspect, the pesticide is an insect repellant. Examples of insect repellants, include, but are not limited to: 2-ethyl-1,3-hexanediol; N-octyl bicycloheptene dicarboximide; N,N-diethyl-M-toluamide; 2,3:4,5-Bis (2-butylene) tetrahydro-2-furaldehyde; Di-n-propyl isocinchomeronate; and 2-hydroxyethyl-n-octyl sulfide.

In a particular aspect, the pesticide is a water-soluble herbicide. The term “water-soluble” as used herein in relation to a herbicide or salt thereof means having a solubility in deionized water at 20° C. of not less than about 200 g/l. In some aspects, the water-soluble herbicides have a herbicidal active acid or anionic moiety and are most usefully present in the form of one or more water-soluble salts. The aqueous phase can optionally contain, in addition to the water-soluble herbicide, other salts contributing to the ionic strength of the aqueous phase. In one particular aspect, the agrochemical formulation includes a water-soluble herbicide and the adjuvant composition of the present disclosure.

Water-soluble herbicides include acifluorfen, acrolein, amitrole, asulam, benazolin, bentazon, bialaphos, bromacil, bromoxynil, chloramben, chloroacetic acid, clopyralid, 2,4-D, 2,4-DB, dalapon, dicamba, dichlorprop, difenzoquat, diquat, endothall, fenac, fenoxaprop, flamprop, flumiclorac, fluoroglycofen, flupropanate, fomesafen, fosamine, glufosinate, glyphosate, imazameth, imazamethabenz, imazamox, imazapic, imazapyr, imazaquin, imazethapyr, ioxynil, MCPA, MCPB, mecoprop, methylarsonic acid, naptalam, nonanoic acid, paraquat, picloram, quinclorac, sulfamic acid, 2,3,6-TBA, TCA, triclopyr and water-soluble salts thereof.

The amount of pesticide included in the agrochemical formulation of the present disclosure will vary according to a number of parameters such as the target substrate to be treated, the area to be treated, etc. In general, a rate of application from about five grams to about four kilograms per hectare (g/ha) of pesticide may be suitable in some aspects.

The agrochemical formulations of the present disclosure may be used in conventional agricultural methods. For example, the pesticide and adjuvant composition may be mixed with water if desired and applied post-emergence to a desired target substrate by any means, such as airplane spray tanks, knapsack spray tanks, cattle dipping vats, farm equipment used in ground spraying (e.g., boom sprayers, hand sprayers), and the like.

As discussed above, in accordance with some aspects, the agrochemical formulation can be a concentrate composition, which can be diluted in a suitable volume of water to form a spray formulation (e.g., a tank mix composition) for applying to the target substrate. The concentrate composition can be in liquid, solid, or semi-solid form.

In one aspect, the amount of the pesticide in the concentrate composition can range from about 1% by weight to about 80% by weight, alternatively from about 16% by weight to about 60% by weight, alternatively from 35% by weight to about 55% by weight, based on the total weight of the concentrate composition. The amount of the adjuvant composition in the concentrate composition may range from about 0.0001% by weight to about 30% by weight, alternatively between from about 0.001% by weight to about 20% by weight, or alternatively from about 0.01% by weight to about 10% by weight percent, or alternatively from about 0.1% by weight to about 5% by weight, or even alternatively from about 0.5% by weight to about 3% by weight, based on the total weight of the concentrate composition.

The concentrate composition can be diluted by a user with water to render a spray formulation containing from about 0.01% by weight to about 15% by weight, alternatively from about 0.1% by weight to about 5% by weight, alternatively from about 0.2% by weight to about 2% by weight of the pesticide, based on the total weight of the spray formulation. The spray formulation can typically contain from about 0.0001% by weight to about 6% by weight, alternatively from about 0.001% by weight to about 5% by weight, alternatively from about 0.01% by weight to about 4% by weight percent of the adjuvant composition of the present disclosure, based on the total weight of the spray formulation.

In still other aspects of the present disclosure, the pesticide and adjuvant composition are combined to form a “ready-to-use” (RTU) spray formulation. The RTU spray formulation can be prepared by a user by diluting a concentrate composition as described above, or alternatively can be provided to the user as is. For example, the RTU spray formulation can contain from about 0.5% by weight to about 5% by weight, alternatively from about 0.75% by weight to about 3% by weight, alternatively from about 1.5% by weight to about 2.5% by weight of the pesticide, based on the total weight of the RTU spray formulation. The RTU spray formulation can also contain from about 0.01% by weight to about 5% by weight, alternatively from about 0.2% by weight to about 3% by weight, alternatively from about 0.5% by weight to about 2% by weight of the adjuvant composition of the present disclosure. The balance of the RTU composition can be water.

In accordance with another aspect, the presently described technology provides a method for killing or inhibiting or repelling a pest comprising the steps of providing a pesticide in a pesticidally effective amount, providing the adjuvant composition of the present disclosure, combining the pesticide with the adjuvant composition to prepare an agrochemical formulation, and contacting the agrochemical formulation and the pest.

### Examples

### Example 1. Zinc salt of linear alkylbenzene sulfonate

The zinc salt of linear alkylbenzene sulfonic acid (LAS) was made by reacting 300 g of LAS with 36 g of ZnO in the presence of 300 g of methanol at 70° C. for 4 hours. To this mixture was then added 100 g of TERMUL®5500 product (a butyl initiated EO/PO block polymer), 100 g of propylene glycol butyl ether (PGBE), and 50 g of methylated soybean oil (MSO). This mixture was stirred under reduced pressure and heated to 70° C. until all of the methanol was removed. The resulting viscous orange liquid contained 5% Zn metal and formed microemulsions when diluted into hard, medium, and soft waters.

### Example 2. Zinc 2-Ethylhexylphosphate Ester

Methanol (245 g) was added to a round bottom flask equipped with a stir bar, and 332 g of the phosphate ester of 2-ethylhexanol was added and the solution was stirred until homogeneous. ZnO (31 g) was then added and the mixture was heated to 70° C. and stirred for 4 hours. The methanol was removed under reduced pressure and 73 g MSO was added along with 24 g SURFONIC® T-5 product (alkylamine ethoxylate), 20 g TERMUL® 3150 emulsifier, and 20 g TERMUL® 5500 product. The resulting viscous yellow liquid formed microemulsions when diluted into hard, medium, and soft waters.

### Example 3. Zinc/Manganese LAS

A mixed Zn and Mn salt of LAS was produced in this example. 842.3 g LAS was dissolved into 640 g methanol and 48.7 g ZnO and 50.5 g MnO were added slowly and the mixture was stirred and heated to 70° C. for 6 hours. 15 g of triethanolamine (TEA) was then added and methanol was removed under reduced pressure. Then, 140 g PGBE, 70 g MSO, and 112 g TERMUL® 5500 were mixed in to give the final product which contained 4.5% total metals. This product formed microemulsions when diluted into hard, medium, and soft waters.

### Example 4. Zinc/Manganese-Cumene Sulfonic Acid

300 g of cumene sulfonic acid and 300 g methanol were added to a round-bottom flask equipped with a reflux condenser, stir bar, and thermocouple. 28 g ZnO and 28 g MnO were then added slowly and the mixture was stirred and heated to 70° C. for 6 hours. 5 g TEA was then added and the methanol removed under reduced pressure. Then, 200 g water, 40 g SURFONIC® CO-36 surfactant, 44 g tall oil fatty acid (TOFA), and 100 g PGBE were added to form a transparent orange liquid that formed transparent microemulsions when diluted into hard, medium, and soft waters.

### Example 5. Herbicide Activity in Micronutrients

Various herbicides and micronutrient fertilizers were tested for compatibility along with the Zn/Mn-LAS product from Example 3. Fertilizers were added to 342 ppm (WHO) water at room temperature at recommended mix rates and herbicides were mixed in at their own recommended rates. The samples were stored at room temperature for 24 hours and then examined for any modes of failure (Possible failure modes include crystallization, flocculation, phase separation, etc.) The compatibility results are below in Table 1:

TABLE 1

| | Fertilizers | | | | | |
|---|---|---|---|---|---|---|
| | | Nulex | Nulex | | | Zn/Mn- |
| | 9% Zn | Chelate | liquid | Corn | TJ | LAS |
| Herbicide | EDTA | 10XL | Zinc 20 | Mix LS | Micromix | (Ex. 3) |
| Flexstar GT | Pass | Pass | Floccu- | Pass | Pass | Pass |
| (fomesafen + | | | lates | | | |
| glyphosate) | | | | | | |
| Clarity | Pass | Floccu- | Floccu- | Pass | Pass | Pass |
| (Dicamba) | | lates | lates | | | |
| Surpass | Pass | Floccu- | Floccu- | Pass | Pass | Pass |
| (acetochlor) | | lates | lates | | | |
| Powerline | Floccu- | Floccu- | Floccu- | Floccu- | Pass | Pass |
| (imazapyr) | lates | lates | lates | lates | | |
| Roundup | Pass | Pass | Pass | Pass | Pass | Pass |
| PowerMax | | | | | | |
| (glyphosate) | | | | | | |

All comparative fertilizers that passed were clear solutions after storage for 24 hrs and the ones that did not pass failed due to the appearance of flocculated material. The Zn/Mn-LAS product was compatible with all herbicides and produced stable microemulsions in each scenario, showing its usefulness as a tank-mix partner for herbicides.

### Example 6. Zinc Uptake Measurements in Corn Seedlings

In this example, the Zn salt of linear alkylbenzene sulfonate from example 1 was sprayed on corn seedlings that were grown in potting soil and zinc uptake into the plant leaves was measured and compared to uptake of other forms of zinc as described below. The samples that were analyzed were prepared by spraying the leaves with the particular formulation, drying the leaves after spraying, grinding the leaves, digesting them in aqua regia and measuring the concentration of zinc in solution by inductively coupled plasma mass spectrometry (ICP-MS). Spray treatment formulations were prepared as follows, based on an average delivery of 3.3 mL solution per 4 inch square pot (16 in² treated area):
a) deionized water only
b) Ca-LAS/MSO: 1.07 g/L in deionized water
c) ZnSO₄: 1.02 g/L ZnSO₄ in deionized water to approximate the recommended use rate of 1 lb Zn in 20 gallons solution per acre
d) Zn-LAS/MSO (5% w/w Zn, density 1.02 g/mL): 1.07 g/L in deionized water to approximate a use rate of 0.15 lb Zn in 20 gallons solution per acre
e) Zn-EDTA (9% w/w Zn, density 1.31 g/mL): 0.59 g/L in deionized water to approximate the recommended use rate of 0.15 lb Zn in 20 gallons solution per acre.

After 48 hours of incubation, each seedling was cut just above the soil line and the aerial tissue was used for analysis. Seedlings were submerged in a series of three deionized water baths and agitated for 10 seconds. All three wash waters were changed after each 8-10 seedlings and between treatment cohorts. Washed tissue was placed in a clean, dry wide-mouth glass jar and incubated for 4-6 days at 40° C. until dry. Dried tissue was ground with a mortar and pestle to a coarse powder. The results are provided below in Table 2.

TABLE 2

| Spray Formulation | Relative Zinc Concentration |
|---|---|
| Water | 1.0 |
| Ca-LAS/MSO | 0.95 |
| ZnSO₄ | 2.01 |
| Zn-LAS/MSO | 1.82 |
| Zn-EDTA | 1.05 |

The data above was normalized to the water control (set as 1) and represents the average of two separate trials. The results show that the plants sprayed with the formulation from inventive example 1 contained almost twice as much zinc as those sprayed with Zn-EDTA (at the same rate of zinc) and a slightly lower amount of zinc than plants sprayed with ZnSO₄ (at a 6× higher rate of Zn). However, because ZnSO₄ was sprayed at a rate of 1.0 lb/acre while inventive example 1 was sprayed at 0.15 lb/acre, there was a much greater efficiency of zinc uptake with the inventive formulation.

Although making and using various aspects of the present invention have been described in detail above, it should be appreciated that the present invention provides many applicable inventive concepts that can be embodied in a wide variety of specific contexts. The specific aspects discussed herein are merely illustrative of specific ways to make and use the invention, and do not delimit the scope of the invention.

What is claimed is:

1. An adjuvant composition comprising (a) a micronutrient salt obtained from the reaction of a metal-containing compound comprising boron, calcium, copper, iron, magnesium, manganese, molybdenum, nickel, selenium, zinc or a mixture thereof and an organic acid comprising a sulfonic acid, a carboxylic acid, a phosphorus acid, a boric acid or a mixture thereof and (b) an oil, wherein the organic acid comprises a number of carbon atoms to render the micronutrient salt that is formed substantially oil soluble.

2. The adjuvant composition of claim 1 wherein the metal-containing compound comprises metal oxide, a metal carbonate, a metal hydroxide or a mixture thereof of boron, calcium, copper, iron, manganese, magnesium, molybdenum, nickel, selenium or zinc.

3. The adjuvant composition of claim 2, wherein the metal-containing compound is a metal oxide, a metal carbonate, a metal hydroxide or a mixture thereof of calcium, manganese, magnesium or zinc.

4. The adjuvant composition of claim 2, wherein the metal-containing compound is a metal oxide of calcium, manganese, magnesium or zinc.

5. The adjuvant composition of claim 1, wherein the organic acid is a sulfonic acid. represented by the general formula
R₁SO₃H or (R₁)ₓArSO₃H
where R₁ is a hydrocarbyl based group having less than 30 carbon atoms; x is an integer of 1 to 3; and, Ar is an aromatic hydrocarbon nucleus.

6. The adjuvant composition of claim 1, wherein the organic acid is a phosphorus acid selected from 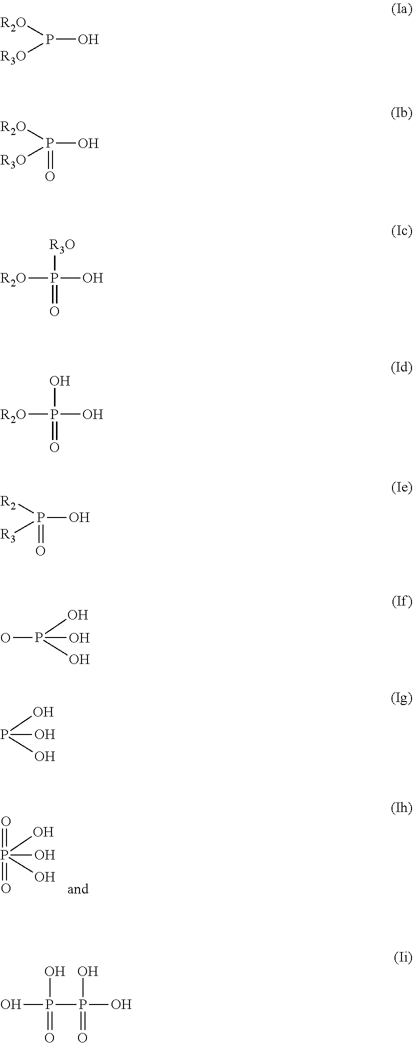
wherein R₂ and R₃ are each, independently, an aliphatic, aromatic or non-aromatic alicyclic hydrocarbon or heterocyclic radical having from 1 to 30 carbon atoms.

7. The adjuvant composition of claim 1, wherein the oil comprises a vegetable oil, a mineral oil, a paraffin oil, a fatty acid ester or a mixture thereof.

8. The adjuvant composition of claim 1, further comprising a surfactant.

9. The adjuvant composition of claim 1, further comprising an auxiliary component.

10. The adjuvant composition of claim 1, wherein the adjuvant composition is substantially free of a chelate.

11. An adjuvant composition comprising (a) 0.01% by weight to 20% by weight of a substantially oil soluble micronutrient salt obtained from the reaction of a metal-containing compound comprising boron, calcium, copper, iron, magnesium, manganese, molybdenum, nickel, selenium, zinc or a mixture thereof and an organic acid comprising a sulfonic acid, a carboxylic acid, a phosphorus acid, a boric acid or a mixture thereof and (b) 0.01% by weight to 45% by weight of an oil, where the % by weight is based on the total weight of the adjuvant composition.

12. The adjuvant composition of claim 11, wherein the metal-containing compound is a metal oxide of zinc or manganese.

13. The adjuvant composition of claim 11, wherein the organic acid has a number of carbon atoms ranging from 1 to 30.

14. The adjuvant composition of claim 11, further comprising (c) 0.1% by weight to 25% by weight of the surfactant, where the % by weight is based on the total weight of the adjuvant composition.

15. The adjuvant composition of claim 14, further comprising (d) 0.1% by weight to 90% by weight of an auxiliary component, where the % by weight is based on the total weight of the adjuvant composition.

16. An agrochemical formulation comprising the adjuvant composition of claim 1 and a pesticide.

17. The agrochemical formulation of claim 16, wherein the pesticide is a water soluble herbicide.

18. The agrochemical formulation of claim 17, wherein the water soluble herbicide is selected from glyphosate, 2,4-D, dicamba and glufosinate.

19. A method for killing, inhibiting or repelling a pest which includes contacting the agrochemical formulation of claim 16 and a pest.

20. A container comprising the adjuvant composition of claim 1.
